(19) United States
(12) Patent Application Publication
(10) Pub. No.: US 2011/0252360 A1
(43) Pub. Date: Oct. 13, 2011

(54) BUSINESS SOFTWARE APPLICATION SYSTEM AND METHOD WITH PRODUCTIVITY BAR AND EXPRESSION ENGINE

(75) Inventors: David Wheeler, San Jose, CA (US); Clint Oram, San Mateo, CA (US); Majed Itani, San Jose, CA (US); Lam Huynh, Houston, TX (US); Lila Tretikov, Los Gatos, CA (US)

(73) Assignee: SugarCRM, Inc., Cupertino, CA (US)

(21) Appl. No.: 13/049,823

(22) Filed: Mar. 16, 2011

Related U.S. Application Data
(60) Provisional application No. 61/314,543, filed on Mar. 16, 2010.

(51) Int. Cl. G06F 3/048

(52) U.S. Cl. 715/781; 715/764

(57) ABSTRACT

A business software application system and method are provided that have a productivity bar and an expression engine.

### PRIORITY/CLAIM/RELATED APPLICATIONS

This applications claims the benefit under 35 USC 119(e) and 120 to U.S. Provisional Patent Application Ser. No. 61/314,543, filed on Mar. 16, 2010 and entitled “Business Software Application System and Method with Productivity Bar and Expression Engine”, the entirety of which is incorporated herein by reference.

### APPENDIX

Appendix A (12 pages) forms a part of this specification and is incorporated herein by reference.

### FIELD

The system and method relate generally to a business software system and method and in particular to a software-based system and method for providing customer relationship management.

### BACKGROUND

Customer relationship management (CRM) systems and solutions are well known. For example, typical known CRM systems include Microsoft® CRM, SalesForce, a CRM product provided by SalesForce.com, Netsuite CRM, and SAP Business One CRM. However, conventional CRM systems have significant limitations that include a lack of flexibility, high costs, and a closed-source structure which is embedded into the traditional product offerings. These limitations have led to a failure rate of over 70% with traditional CRM implementations. Thus, it is desirable to provide a customer relationship management system and method that overcomes these limitations of typical business software application systems, such as CRM systems, and it is to this end that the system and method are directed.

### BRIEF DESCRIPTION OF THE DRAWINGS

FIG. 1A is a diagram illustrating an implementation of a business software application system, implementing a customer relationship management system, that incorporates various features;

FIG. 1B illustrates more details of the business software application system that incorporates various features;

FIG. 2 is a diagram illustrating an example of the user interface of the system in FIGS. 1A and 1B;

FIG. 3A illustrates an example of an implementation of a configurable navigation element of the business software application system;

FIG. 3B illustrates an example of the configurable navigation element of the business software application system being used to access functionality of the business software application system;

FIGS. 4A-4F are examples of user interface screens being browsed by a user of the business software application system;

FIG. 5 illustrates an example of a user interface element for a new call record creation that may be added to the navigation element of the business software application system;

FIG. 6 illustrates an example implementation of the expression engine of the business software application system;

FIG. 7 illustrates an example of a dependent drop down; and

FIGS. 8 and 9 illustrates examples of the user interface of the dependent drop down.

### DETAILED DESCRIPTION OF ONE OR MORE EMBODIMENTS

The system and method are particularly applicable to an customer relationship management software system and it is in this context that the system and method will be described. It will be appreciated, however, that the algorithms, data structures, processes and modules of the system and method have greater utility since these modules, algorithms, data structures and processes disclosed herein can be equally applied to other CRM systems, as well as other business software application systems as well as other database software systems. For purposes of illustration, the described system is an implementation in a customer relationship management (CRM) and groupware system. In the example below, the CRM and groupware system described below is the Sugar Enterprise version 6.0 that is soon to be commercially available from SugarCRM Inc.

The system may be implemented using a base class known as SugarBean, and a data retrieval API. A few of the methods provided in the base class include methods for building list queries, saving, and retrieving individual items. Each specific type of data creates a subclass of this base class. The base class is called SugarBean in the illustrative example that is described below. There is at least one subclass of SugarBean for each module. SugarBeans also are used for creating database tables, cleaning out database tables, loading records, loading lists, saving records, and maintaining relationships. One example of a SugarBean subclass is a Contact subclass. The Contact subclass is a simple object that fills in some member variables on the SugarBean and leverages SugarBean for much of its logic and functionality. For example, the security associated with the Contact subclass is automatically created for Contact by SugarBean that contains, among other things, the functions and processes that are shared by the other modules. Another example of a SugarBean subclass is Users which is a module that is security related and contains the list of users as well as users who should not have row level security (described below in more detail) applied to them. For this reason these modules have the bypass flag set to skip adding the right join for verifying security. The SugarCRM Sugar Professional system is a web based system with many concurrent users. Since this program contains critical data to the users, it is imperative that they have quick access to the system and their data. The most frequent activity in the program is to look at existing data.

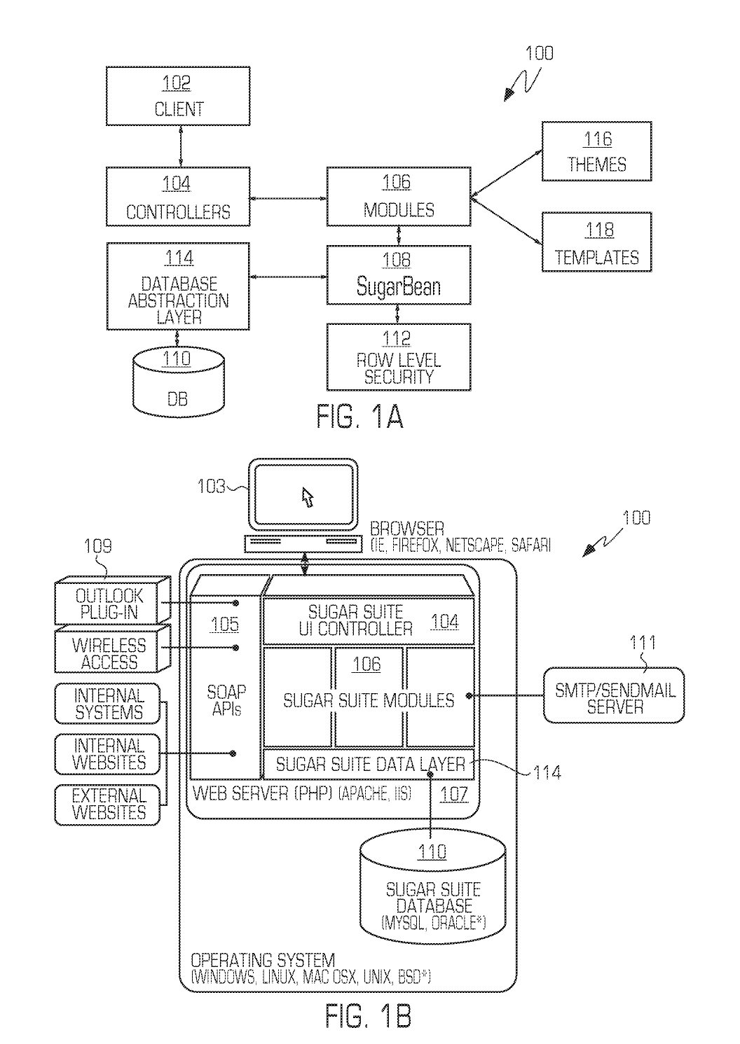

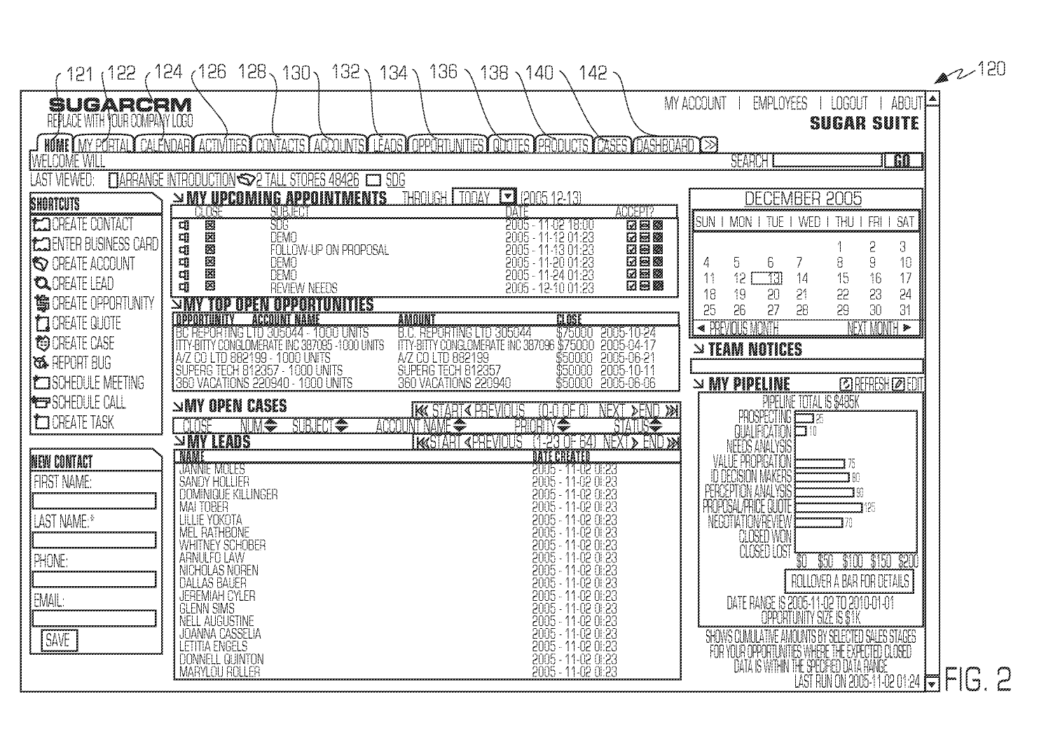

FIG. 1A is a diagram illustrating a customer relationship management (CRM) system 100 that is an example of a software-based business software application. In one embodiment, the system 100 may be implemented as a software system and the elements shown in FIGS. 1A and 1B are thus implemented as a plurality of lines of computer code that may be executed by a processor of a computer system, such as a server computer wherein the various lines of computer code are stored in a memory associated with the computer system and the system interfaces with a database 110 that stores the data associated with the system 100. The system may have one or more clients 102, such as a browser application executed on a typical computing device (a browser client session), that accesses the system over a communications network 103 such as the Internet, a cellular network, a wireless network and the like. The computing devices may include a laptop, table or desktop computer system, a PDA, a mobile phone, a portable wireless email device and the like. The client's 102 interactions with the system are managed and go through a set of one or more controllers 104. The controllers 104 are the entry-point into the system for an entity that is using the system wherein the entity may be a person who accesses the system, such as by using a browser application, a computing device or a software program that uses this entry point. The controllers 104 take care of functions and operations including, for example, session tracking, session security and user authentication. The controllers also, for each user, prepare the screen/user interface or the wrapper for the content and determine which module of the application the user is trying to access and get the requested module to process the request.

The system has one or more modules 106 that are components of application functionality and provide certain functionality to the entity accessing the system. The modules 106 of the exemplary CRM system shown in FIG. 1A may include, by way of example, a portal module, a calendar module, an activities module, a contacts module, an accounts module, a leads module, an opportunities module, a quotes module, a products module, a cases module, a bug tracker module, a documents module, an emails module, a campaigns module, a project module, an RSS module, a forecasts module, a reports module and a dashboard module. The system may include different, more or fewer modules and the systems with those other combination of modules are within the scope of the system and method. Each of these modules provides a different functionality to the users of the system so that, for example, the calendar module provides a calendaring functionality to the CRM system that is instantiated with the system. The system may also include an administration module that handles the typical administrative functions of the system. In the exemplary system shown in FIG. 1A, each module contains a subclass of a SugarBean base object 108 and each module references the SugarBean to retrieve the data from the database 110 required for display and uses certain functions and operations instantiated in the SugarBean base object.

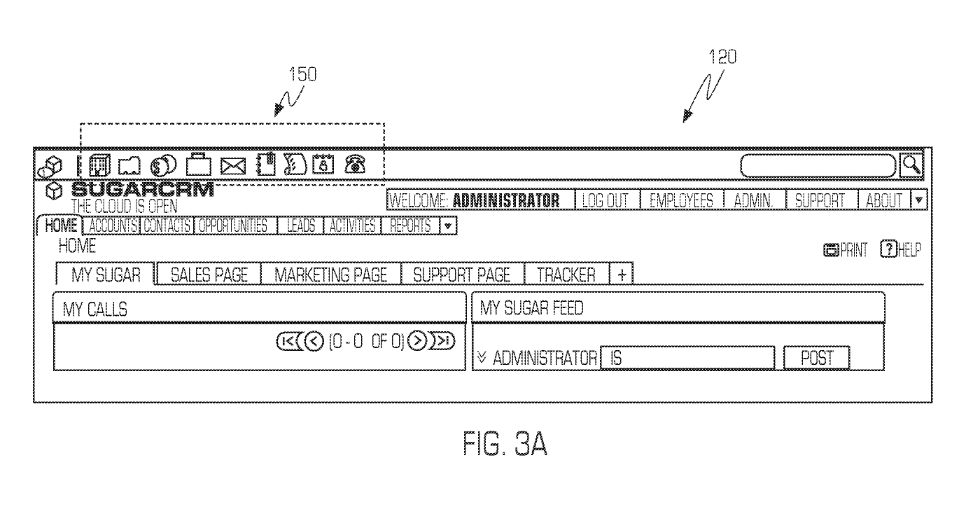

FIG. 2 is a diagram illustrating an example of the user interface 120 of the system in FIGS. 1A and 1B. The user interface may include a home tab 121 (that is selected in FIG. 2) that provides a general overview of Cases, Opportunities, Appointments, Leads, Tasks, Calendar, Team Notices, and Pipeline for the particular user since each user interface is customized for each user based on the access levels and parameters associated with that particular user. The home tab may also include shortcuts to enter various different types of data, and a quick form for new contacts. The home tab also provides a quick overview of what customer tasks and activities that the user needs to focus on today. The portal module (selected using a “My portal” tab 122), contains a series of shortcuts which can link to any web site chosen by the user that may include e-mail, forums, or any other web-based application, allowing the system to become a single user interface for multiple applications. The calendar module may be selected by a calendar tab 124 and allows the user to view scheduled activities (by day, week, month or year), such as meetings, tasks, and calls. The system also allows the user to share his/her calendar with coworkers which is a powerful tool for coordinating the daily activities. The activities module is selected using an activities tab 126 and allows the user to create or update scheduled activities, or to search for existing activities. By managing Activities within the context of an Account, Contact, Lead, Opportunity, or Case, the system allows the user to manage the myriad of calls, meetings, notes, emails and tasks that the user needs to track in order to get the job done. The tasks are for tracking any action that needs to be managed to completion by a due date, the notes allow the user to capture note information as well as upload file attachments, the calls allow the user to track phone calls with leads and customers, meetings are like calls, but also allow the user to track the location of the meeting and emails allow the user to archive sent or received email messages and to send or receive email messages.

The contacts module is accessed by a contacts tab 128 and allows the user to view a paginated contact list, or search for a contact. The user can click on a specific contact to zoom in on the detailed contact record and, from a specific contact record, the user may link to the related account, or leads, opportunities, cases, or direct reports (related contacts). Within the system, contacts are the people with whom the organization does business. As with accounts, the system allows the user to track a variety of contact information such as title, email address, and other data. Contacts are usually linked to an Account, although this is not required. The accounts module may be accessed using an accounts tab 130 and the user may view a paginated account list, or search for an account. The user can click on a specific account to zoom in on the detailed account record and, from a specific account record, the user may link to related contacts, activities, leads, opportunities, cases, or member organizations. Accounts are the companies with which the organization does business and the system allows the user to track a variety of information about an account including website, main address, number of employees and other data. Business subsidiaries can be linked to parent businesses in order to show relationships between accounts.

The leads module may be accessed by a leads tab 132 that permits the user to view a paginated list of leads, or search for a specific lead. The user can click on an individual lead to zoom in on the lead information record and, from that detailed lead record, the user can link to all related activities, and see the activity history for the lead. Leads are the people or companies with whom the organization might do business in the future. Designed to track that first point of interaction with a potential customer, leads are usually the hand off between the marketing department and the sales department. Not to be confused with a contact or account, leads can often contain incomplete or inaccurate information whereas contacts and accounts stored in Sugar Enterprise are core to many business processes that require accurate data. Leads are typically fed into the Sugar Enterprise stem automatically from your website, trade show lists or other methods. However, the user can also directly enter leads into Sugar Enterprise manually.

The opportunities module is accessed by an opportunities tab 134 and permits the user to view a paginated list of opportunities, or search for a specific opportunity. The user can click on an individual opportunity to zoom in on the opportunity information record and, from that detailed opportunity record, the user can link to all related activities, see the activity history for the opportunity, and link to related leads and contacts. Opportunities track the process of selling a good or service to a potential customer. Once a selling process has commenced with a lead, a lead should be converted into a contact and possibly also an account for example among other items. Opportunities help the user manage the selling process by tracking attributes such as sales stages, probability of close, deal amount and other information. The quotes module may be accessed by a quotes tab 136 and permits the user to view a paginated list of customer quotes, or search for a specific quote. The user can click on an individual quote to zoom in on the detailed quote information. A quote is formed by referencing product and pricing from a catalog of products you may create. A presentation quality Portable Document Format (PDF) representation of the quote may be created to fax or email to a client. Quotes may be associated with , for example, Accounts, Contacts, or Opportunities among other modules in the system and the system is not limited to a quote being associated with any particular set of modules.

The products module may be accessed by a products tab 138 and permits the user to view a paginated list of products, or search for a specific product. The user can click on an individual product to zoom in on the detailed product information. A product is used when assembling a customer quote. The cases module may be accessed using a cases tab 140 and may permit the user to view a paginated list of cases, or search for a specific case. The user can click on an individual case to zoom in on the case information record and, from that detailed case record, the user can link to all related activities, see the activity history for the case, and link to related contacts. The cases are the handoff between the sales department and the customer support department and help customer support representatives manage support problems or inquiries to completion by tracking information for each case such as its status and priority, the user assigned, as well as a full trail of all related open and completed activities. A dashboard module may be accessed using a dashboard tab 142 and permits the user to view a dashboard of the information in the CRM system.

The documents module may show the user a list of documents that the user can access, view and/or download. The user can also upload documents, assign publish and expiration dates, and specify which users can access them. The email module allows the user to write and send emails and to create Email Templates that can be used with email-based marketing campaigns. The user can also read, compose, save drafts, send and archive emails. The campaigns module helps the user implement and track marketing campaigns wherein the campaigns may be telemarketing, web banner, web tracker, mail or email based. For each Campaign, the user can create the Prospects list from the Contacts or Leads or outside file sources. The projects module helps the user manage tasks related to specific projects. Tasks can be assigned to different users and assigned estimated hours of effort and, as tasks are in progress and completed, users can update the information for each task. The RSS module permits the user to view the latest headlines provided by your favorite Really Simple Syndication (RSS) feeds. These feeds provide news or other web content that is distributed or syndicated by web sites which publish their content in this manner. The system has information on hundreds of RSS feeds available as supplied, and others may easily be added.

The forecasts module shows the user his/her committed forecast history and current opportunities. For managers, the user can view your team's rolled up forecasts. The reports module shows the user a list of saved custom reports not yet published, as well as a list of Published Reports. Saved reports may be viewed, deleted or published, and published reports may be viewed, deleted or un-published. Clicking on the name of a report zooms to the detailed definition of the report criteria (fields to be displayed, and filter settings) for that report, permitting the user to alter the criteria, and re-submit the report query. Finally, the dashboard module displays a graphical dashboard of the user's Opportunity Pipeline by Sales Stage, Opportunities by Lead Source by Outcome, Pipeline by Month by Outcome, and Opportunities by Lead Source. The system also supports users putting graphs from their reports directly on their dashboards.

Returning to FIG. 1A, the system also includes the database 110 that contains the data of the system and a security module 112 (row level security) that implements the security methods to control access to the data in the database 110 since the database is shared by all users of the system and the data must be segregated based on the users and their access level to different pieces of data. The system may also include a database abstraction layer 114 that is coupled between the database 110 and the SugarBean object 108 and acts as an interface between the database 110 and the SugarBean object 108. The SugarBean object 108 provides the base logic required for retrieving, making available and writing information to/from the database and each module creates subclasses of SugarBean (an example of which was described above) to provide module specific details, module specific data and module specific data views. During the process of retrieving data from the database, the SugarBean 108 makes calls that populate the row level security information into the SQL engine/database management system that retrieves the data.

Once the data is retrieved from the database by the SugarBean object 108, the module uses a template mechanism 118 and a theme 116 to produce the requested presentation (user interface) for the user. The template mechanism reformats the data from the database 110 into a particular form while the theme adjusts the user interface according to the user's preferences.

If, for instance, the user requests an HTML presentation of the detail view of the contact module for a specified contact, the system may perform that request as will now be described. The request of the user is directed to controller named index.php that handles most of the logic for the main application. The controller loads the current user information, verifies authentication and session information for the particular user session, loads the language for the user (based on the user preferences) and generates some of the user interface shell. The controller then calls the contact module and request the detail view for the specified contact. The contact module then retrieves the requested contact using the Sugarbean. The SugarBean verifies row level security for the requested contact at this point (with assistance from the security module 112. If the record is not retrieved successfully, then the process aborts and the user is not allowed to view the data for the record. If the retrieve process succeeds with the requested contact data, the Contact module uses the templating mechanism, such as for example XTemplate or Smarty, in the template mechanism 118 and the code for the current user's theme (retrieved by the theme module 116) is used to create the user interface for the presentation of the particular Contact data to the particular user. The resulting user interface then is sent back to the computing device with of client that requested it.

FIG. 1B illustrates more details of the customer relationship management system 100. Like elements shown in FIGS. 1A and 1B have like reference numerals. The system may interface with a typical browser application 103 (being executed by a computing device) that can access the system 100 over the web. For example, the examples of the user interface below are web-based views generated by the system and displayed on a browser application. The system may further comprise an application programming interface (APIs) portion 105, that may preferably use the well known simple object access protocol (SOAP), to interface with other existing system and applications. For example, the APIs may be used to interface to an email plug-in 109, such as an SugarCRM Plug-In for Microsoft Outlook®, that enhances the email program to allow it to interact with the system 100. As shown, the system 100, in one implementation, is implemented on a web server application 107 (that may be the well known Apache web server that includes IIS functionality) that generates dynamic web pages (using the known PHP language). The web server and the other elements of the system may be implemented as software running on one or more servers wherein the servers may use various different operating system as shown in FIG. 1B. The system 100 may also have an email module 111 capable of sending email via a local program (that may preferably be sendmail) or an email server leveraging the SMTP protocol. Now, a configurable navigation metaphor (also known as a productivity bar) of a business software application, such as a CRM system, is described in more detail.

Configurable Navigation Metaphor

The business software application described above in FIGS. 1A, 1B and 2 may include a set of user interface elements created to enhance productivity of an end user of the business software application system. The set of user interface elements alter the application navigation structure and allow the end user to configure visual navigation elements that may provide access to any action within the application more quickly and with fewer steps. This set of elements may appear as a variety of visual elements, for example a top overlay, a floating window, or a roll-over menu. The actions presented in such an element may be user-specified or pre-created by the application administrator. Additionally, the business software application described above may ship with a set of default elements for the convenience of the end user.

The Configurable Navigation metaphor presents the end user of the application with the ability to configure and control the navigation mechanisms of the application to match his or her individual work patterns. For example, a sales operations professional may need rapid access to a set of purchasing functions in a specific order, such as: creating an opportunity, setting a task and assigning a call. All of these actions can be grouped together for quick access on one of the selected navigation elements so that the sales person can then access those actions with single click, regardless of the location of those items within the application's navigation structure.

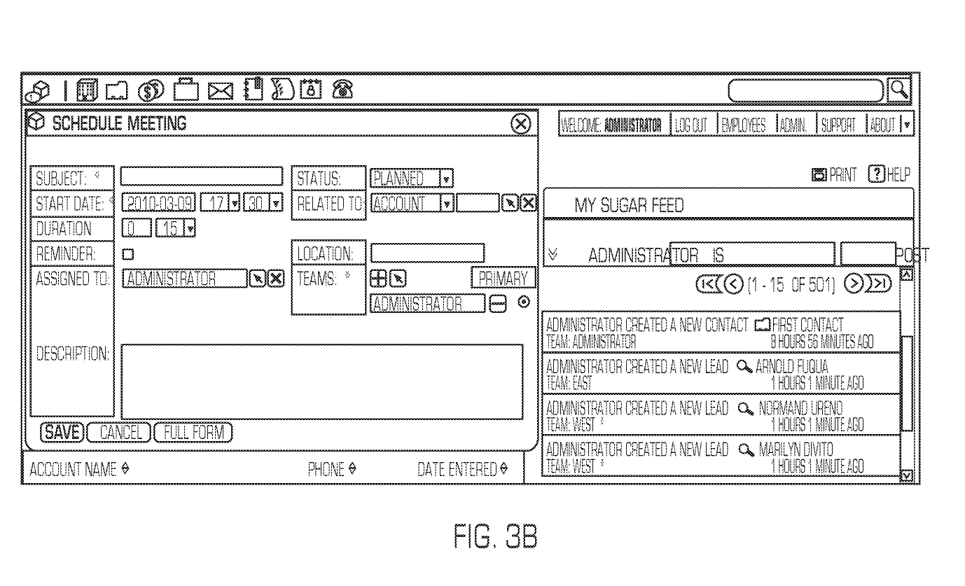

FIG. 3A illustrates an example of an implementation of a configurable navigation element of the business software application system user interface 120. In this specific example, a configurable navigation element 150 (shown with a box around the navigation elements) shows Quick Create tasks presented to the end user. The Quick Create tasks allow the user of the application to short-cut the typical navigation path to a Create function or a set of Create functions that may appear at various levels of depth within the business software application, but may be required by the user to be easily and quickly accessible on demand.

In such a case, the user may choose to place those select functions on the Configurable Navigation element. FIG. 3B illustrates an example of the configurable navigation element of the business software application system being used to access functionality of the business software application system. In this example, the access to creation of entities within the business software application that is the Create Meeting quick-create is open. This type of access is a result of an “interrupt” within a typical usage activity pattern. While a typical case scenario may involve a routine of sequential user functions, in this case an assumption is made that the application end user may be interrupted by an external request, such as a phone call. This type of interruption creates a set of requirements for the end user that are difficult to satisfy with a typical application and even harder to expose as a top-level UI access element:

1. The current workflow is interrupted and the current work needs to be saved.

2. A new task must be accessed and accomplished rapidly without navigating away from the interrupted task and leaving the current screen.

3. The workflow must be resumed after the interruption is handled at the same place where the end user has left off.

While this type of usage scenario is common, the control of this behavior is usually non-programmatic and non-optimized. This is not typically handled in application workflow due to the variations in individual users' work patterns and the complexity involved in pre-defining these optimizations for the end user. The business software application can address these challenges by allowing individual end-users to select a range of activities both for their core workflow as well as the set of typical interrupts and configure the navigation explicitly to optimize for time spent within the application and minimize the amount of busy work and inefficiencies present in applications by exposing those functions most relevant to the user's specific usage.

Adoptability and Usage Learning For Configurable Navigation Element

The configurable navigation system of the business software application may be enriched with an adoptable learning process that may be implemented to automate the navigation system for individual and group user patterns. The processes may take into account specific user inputs, such as length of time spent in a specific location of the application and most widely used sequence of user-triggered events, anomalies (interrupts) in the usage flow; it then pragmatically calculates the most valuable navigation paths for the specific user or a group of users.

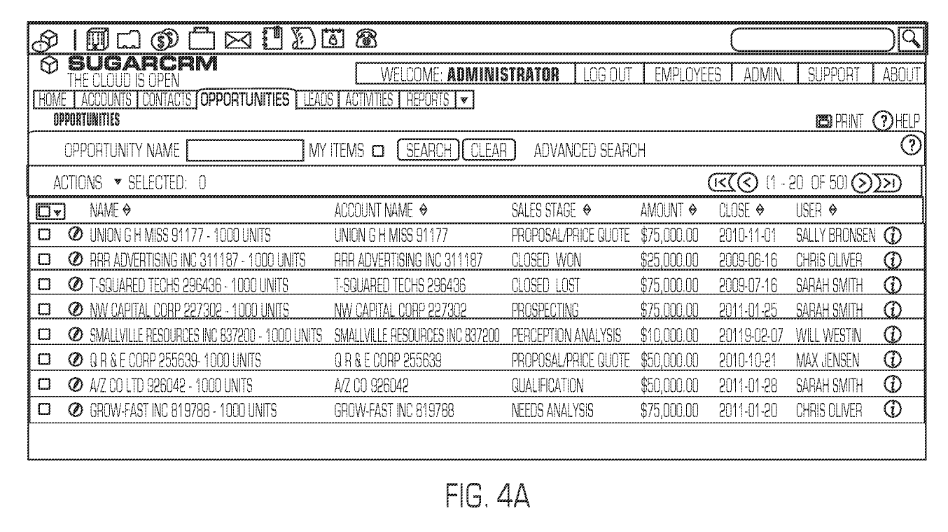

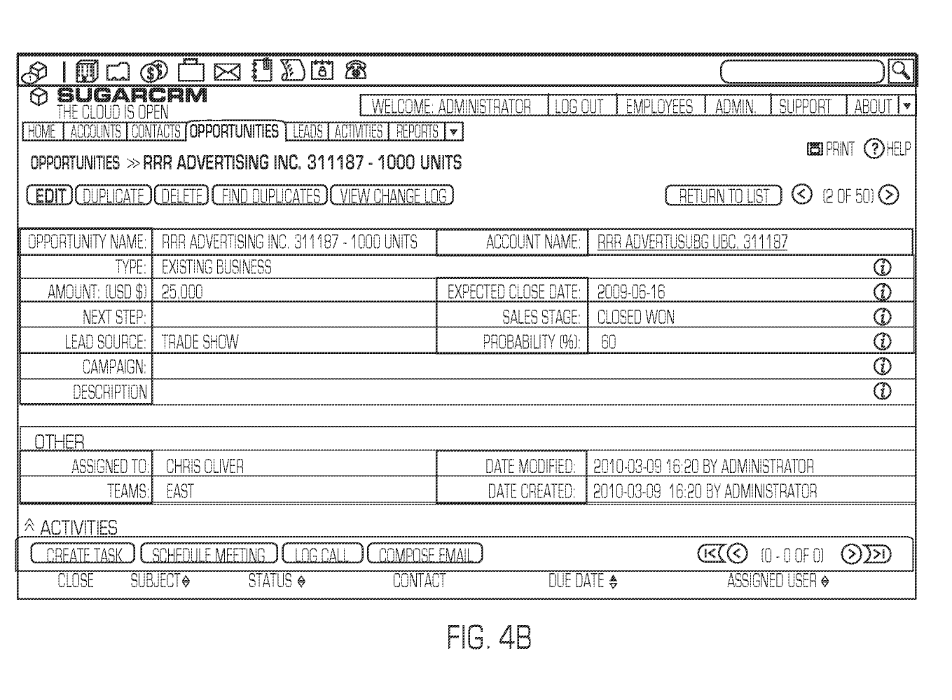

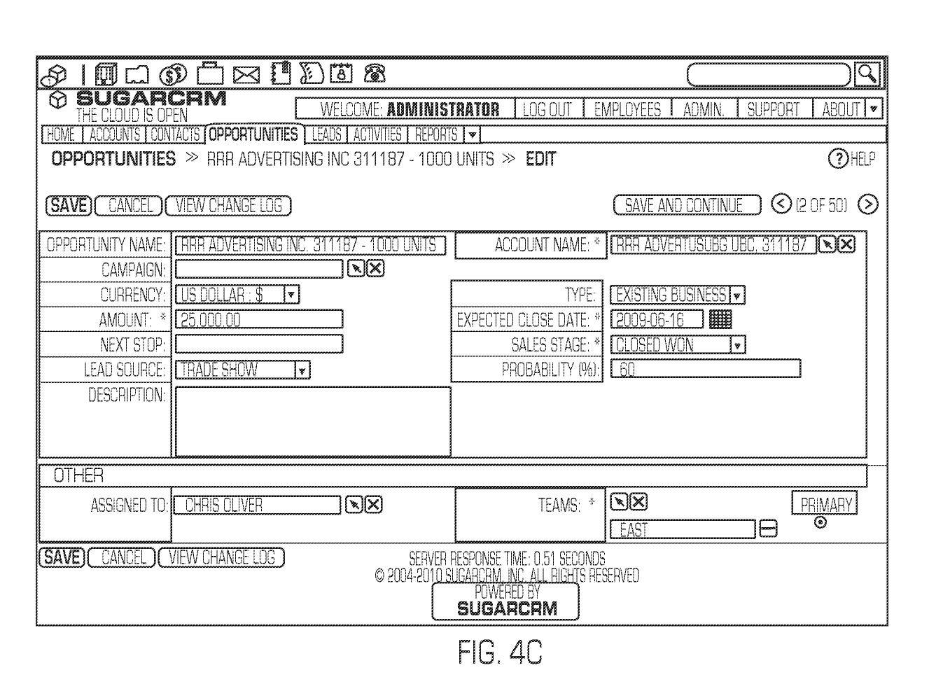

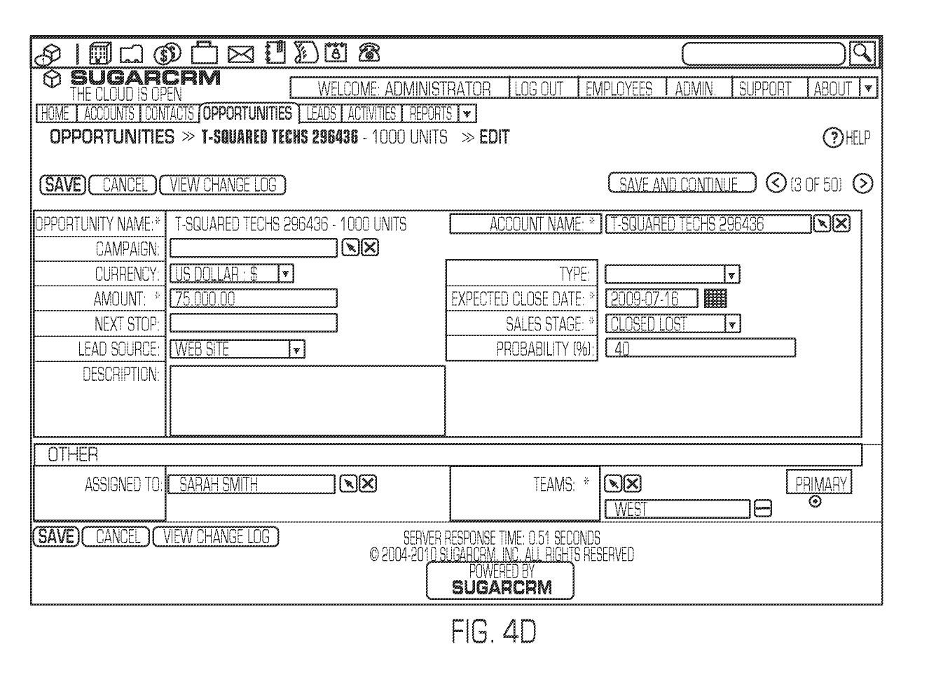

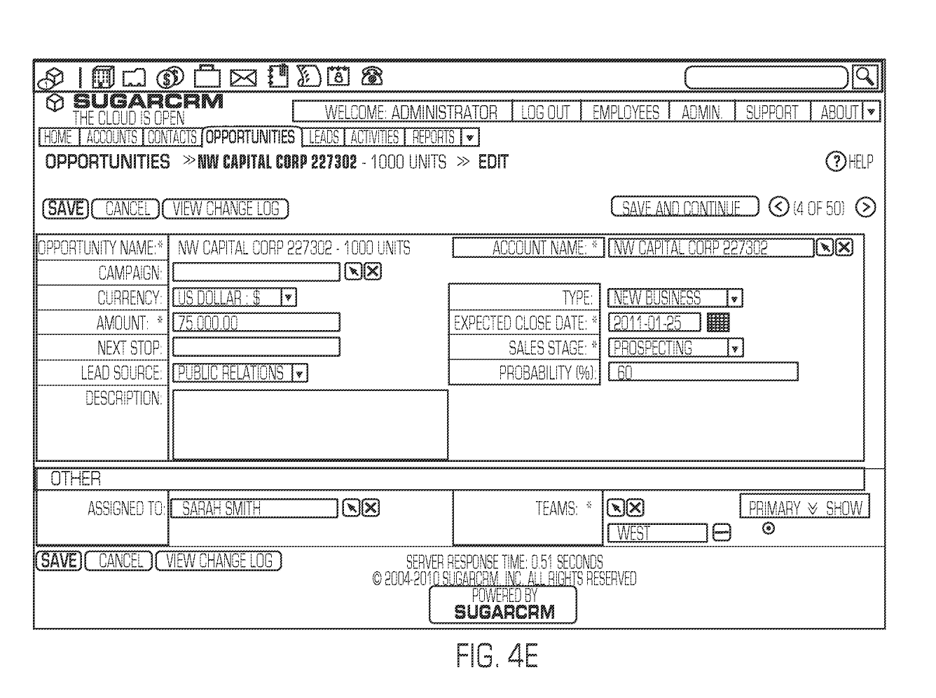

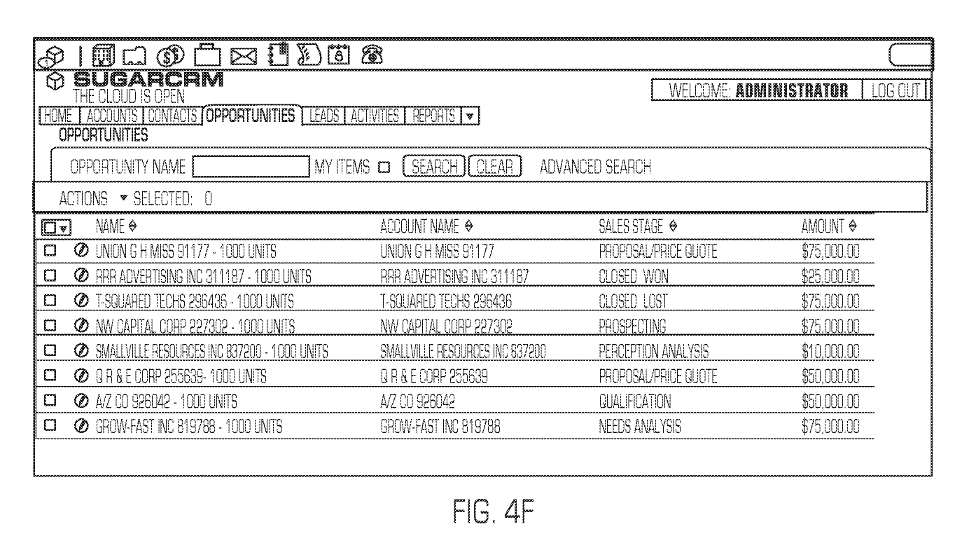

For a simple example, take a sequence of clicks typical for a sales user. In this scenario, assume that the user is typically navigating through the series of screens as shown in FIGS. 4A-4F. An example of such navigation may look like this: 1L−>2D−>3E−>4E−>5E−>1L . . . wherein “L” denotes a list view of a record type, “D” denotes a detail view of a record, and “E” denotes an edit action. This usage sequence may be approximated based on the distance calculation from any given navigation location in the navigation tree, and the pattern can be further inferred by correlating the strings of navigation steps. Once the pattern is learned, the noise patterns can be further analyzed to identify specific interrupts, if any are present in a user's workflow cycle. The system may then create a set of navigation elements to allow the user most direct path to the target screens.

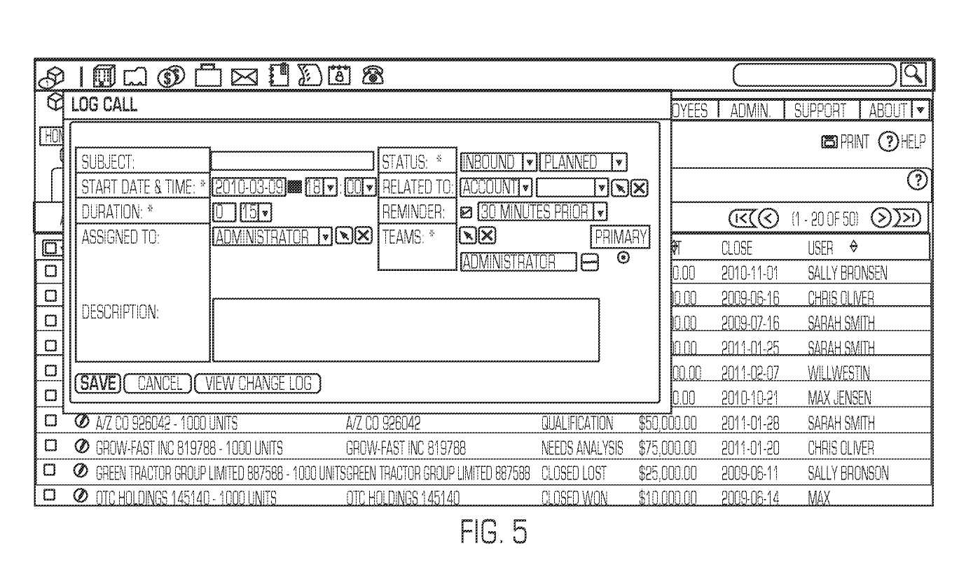

Once the behavioral navigation patterns are learned by the system, they can be applied to the configuration of the user interface elements within the application. For example, a high probability of an item creation while the user is executing a specific workflow may trigger for that item creation navigation item to appear on the navigation bar. Considering the example in the previous paragraph and adding the detection of an interrupt such as new Call Record, the user interface element for new Call Record creation may be added to the navigation element as shown in FIG. 5.

Configuration For Configurable Navigation Element

The administration part of the business software application may include configuration settings for the navigation metaphor. These configurations may specify location, visual representation, sequence patterns, actions and other parameters of a navigation element. This function allows the application user to configure the create elements used and place them into the action container.

The business software application configurable navigation system may be modified at multiple levels: default level, system (administrator) level, and user level. The system configuration can be performed at the studio and module builder parts of the business software application that are used to create and configure sub-applications based on the business software application platform functionality described in commonly owned co-pending patent application Ser. No. 12/200,301, filed on Aug. 28, 2008 with the title “CRM system with Drill Downs, ACLs, Shared Folders, Tracker and Module Builder” and described in commonly owned co-pending patent application Ser. No. 12/432,086, filed on Apr. 29, 2009 and entitled “Business Software Application System and Method”, both of which are herein incorporated by reference. Specifically, FIG. 3B, shows one embodiment of configuration of quick-create elements. The system may be configured for implicit adaptability based on individual user's navigation patterns and workflows.

Expression Engine

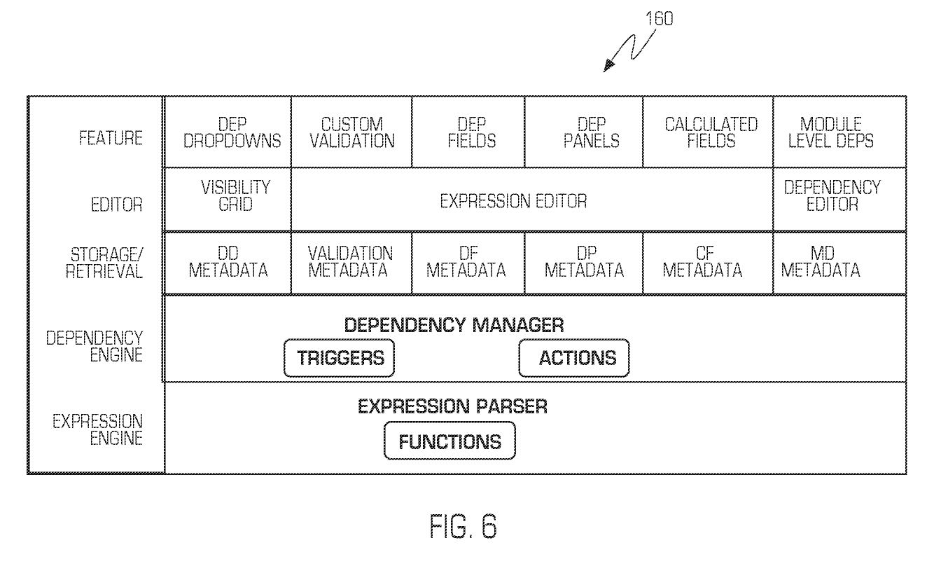

FIG. 6 illustrates an example implementation of the expression engine 160 of the business software application system. The expression engine implements a web application scripting engine designed to allow for processes or “Dependencies” to execute under multiple environments, including, but not limited to mid-tier (such as PHP), client-side (such as javascript), Storage-tier (such as database) or distributed (such as web-service based) components. The expression engine provides foundation for many high-level features including Calculated Field, Dependent Drop-Down, Dependent Fields, Dependent Panels, and Complex Form validation features. The system may be configured via the User Interface (including all necessary Dependencies and Expressions) as well as directly at the code level.

The terminology for the expression engine is:
Expression: A formula that conforms to the Expression Engine syntax consisting of nested functions and field variables.
Trigger: An Expression, which evaluates to either true or false. Triggers are evaluated whenever a field in the equation is updated or when a record is retrieved.
Action: An Expression combined with a target and a type that modifies the current bean or layout in some way.
Dependency: A complete unit, which includes a trigger and one or more actions.

Expressions

The fundamental object in the expression engine is called an Expression. An Expression can be evaluated, has a parameter count, has a parameter type requirement and a function name. To designate the types within the language there are several sub-classes of the Expression object: NumericExpression, StringExpression, BooleanExpression, EnumExpression, DateExpression, and TimeExpression. Each of the defined functions must be a sub-class of any of these fundamental Expression objects. For example, the add function is a sub-class of NumericExpression, whereas the contains function is a sub-class of StringExpression. The return type is defined by the Extended parent class. All functions may be expressed in a variety of target languages, including PHP and javascript.

Types

The language has several fundamental types. They are: number, string, boolean, enum, date, and time. Functions may take in any of these type or combinations thereof and return as output one of these types.

Triggers

A Trigger is an object that listens for changes in field values and once a change is performed, it will trigger the associated Actions in a Dependency. In fact it is very much like an event listener.

Actions

Actions are functions, which modify a target in some way. Actions require two parameters: a target and an expression. For example, a style action will change the style of a field based on a string expression that is a parameter of the action and passed to the action. A value action will update a value of a field by evaluating a passed in expression.

Dependencies

A Dependency describes a field whose properties must be updated dynamically or a panel which must be hidden when a drop down value is not selected. When a Dependency is triggered, it will appropriately carry out the action it is designed to carry out. The basic Dependency is when a field's value is dependent on the result of evaluating a Expression. For example, consider a page with five fields with ID's “a”, “b”, “c”, “d”, and “sum”. A generic Dependency can be created between “sum” and the other four fields by using an Expression that links them together, in this case an add Expression. So we can define the Expression in this manner: ‘add($a, $b, $c, $d)’ where each field id is prefix-ed with a dollar ($) sign so that the value of the field is dynamically replaced at the time of the execution of the Expression.

An example of a more customized Dependency is when the field's style must be somehow updated to a certain value. For example, the DIV with id “temp” must be colored blue. In this case we need to change the background-color property of “temp”. Therefore, the system can define a StyleAction in this case and pass it the field id and the style change that needs to be performed and when the StyleAction is triggered, it will change the style of the object as we have specified.

Expressions can be further combined and nested to produce complex evaluation mechanisms with multiple distributed entry points across a set or sets of communicating systems or layers of systems. For instance a Dependency may be used to control a complex workflow, which includes extended actions, alternative navigation, and distributed execution. In such a case a workflow may be embodied as a triggered event based on a result of a distinct workflow executed on a remote system. Under this condition the original workflow may send an email or some other notification to a peer application and trigger a SOAP-based Dependency rule. Such a rule may execute based on a checksum appearing in the above email and produce a proactive user notification with an Expression-based navigation URI. Since the Expression can be any lambda-style expression, this evaluation may yield a predicate.

Metadata

One of the features of the code in business software application is that all of the modules are metadata driven (See commonly owned co-pending patent application Ser. No. 12/062,511 filed on Apr. 4, 2008 and entitled “Metadata Drive UI System” which is incorporated herein by reference) which makes it easier for developers to modify the fields in each module. Staying consistent with the metadata driven ideology, one feature of Project Copper is that the JavaScript behind the validation, calculated fields, and dependent dropdowns can be automatically generated using a function and properly defined PHP metadata. The metadata code is located in scripts/metatojs.php and scripts/metadata.php which are attached to the specification as Appendix A and has exemplary metadata code.

Each dependency contains a list of actions and a trigger which much be executed when the page and fields are all loaded, so the metadata is broken down into two parts: the Trigger objects and the Action objects.

$dependency=array(‘trigger’=>array(<trigger def>), ‘actions’=>array(// actions go here . . . ));

Calculated Fields
The expression for the calculation is stored in the vardefs. ‘calculated’=>‘true’, ‘formula’=>‘strlen($name)’
TemplateHandler.php passes the vardefs to DependencyManager.php which returns an array of dependency objects.
Template Handler inserts the dependency javascript into the compiled editview templates.
dependency.js executes the dependencies in the browser.

Now, an example of the use of the expression engine to generate a dependent drop-down dialog user interface is described as an example of the expression engine use.

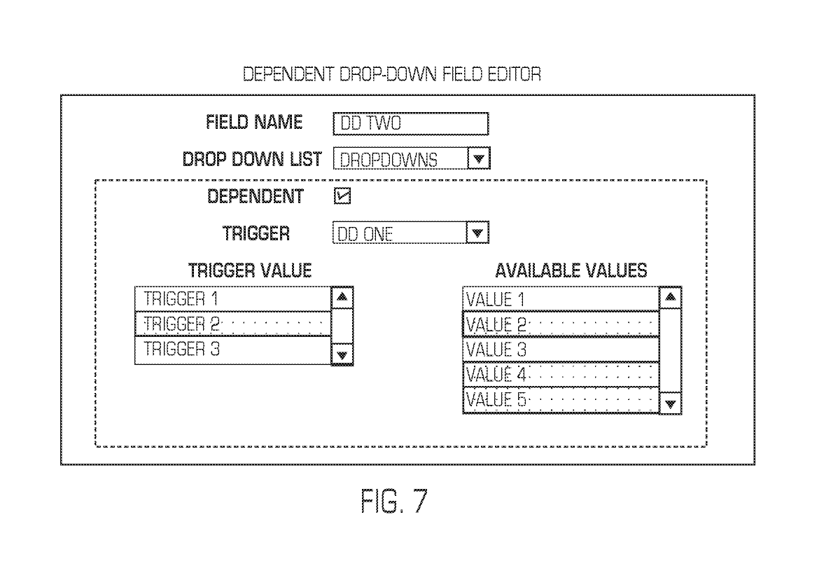

FIG. 7 illustrates an example of a dependent drop down in which the user creates a new drop down field using the user interface in FIG. 7 and sets up the dependency using studio. The drop down logic is saved in metadata format that looks like:

```
′dd_one′ => array(
  ′type′ => ′enum′,
  ′visibility_grid′ => array (
    ′trigger′ => ′dd_one′,
    ′values′ => array (
      ′trigger_1′ => array ( ′value_1′, ′value_2′, ′value_3′),
      ′trigger_2′ => array ( ′value_2′, ′value_4′, ′value_5′)
    )
  )
)
```

Before display, the dependency is converted into a Sugar Dependency Object (in php) and added to the page as javascript code that looks like:

```
new SUGAR.forms.Dependency(
  new SUGAR.forms.Trigger( [ ′dd_one′ ], ′true′),
  [
    new SUGAR.forms.SetOptionsAction(
      ′dd two′,
      ′valueAt (indexOf ($dd one, getDD(″dd one list″)),enum(′
      + ′enum(″value_1″, ″value_2″, ″value_3″), enum(″value_2″, ″value_4″, ″value_5″), enum (″ ″)′
      + ′))′,
      ′valueAt (indexOf ($dd_one, getDD(″dd_one_list″)),enum(′
      + ′enum(″Value 1″, ″Value 2″, ″Value 3″), enum(″Value 2″, ″Value 4″, ″Value 5″), enum (″ ″)′
      + ′))′
    )
  ],
  [ ],
  true
);
```

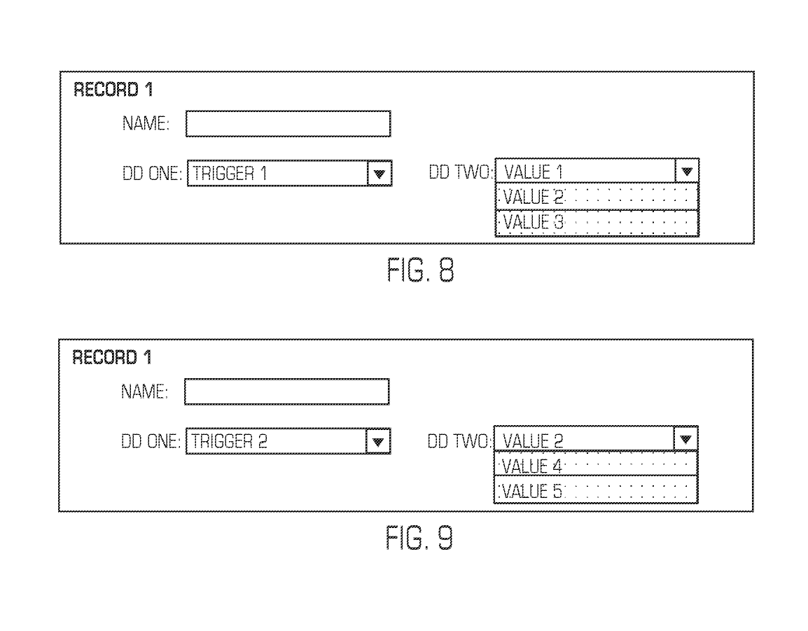

On page load in the business software application, the dependency is executed and the list of options in the dropdown is set as shown in FIG. 8. After the user changes the value of the trigger dropdown, the dependency is evaluated again and the list of options in the target dropdown changes as shown in FIG. 9. In this manner, a dependent drop down within the business software application may be generated.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A business software application, comprising:
a computing device with a processing unit;
a database;
an application having a plurality of lines of computer code wherein the plurality of lines of computer code are executed by the processing unit of the computing device to generate a business application that accesses the database using one or more modules and one or more controllers, that has a user interface and that has a workflow with one or more screens in the workflow; and
wherein the user interface further comprises one or more navigation elements displayed on a screen of the computing device, configured based on a prior use of the business application by a particular user, that allow the particular user to navigate to a particular screen within the workflow of the business application.

2. The business software application of claim 1, wherein the one or more navigation elements are one of a top overlay, a floating window and a roll-over menu.

3. The business software application of claim 1, wherein the application adaptively determines the prior use of the business application by the particular user and automatically generates the one or more navigation elements.

4. The business software application of claim 3, wherein the application further comprises an administrator portion that is used to set a configuration of the one or more navigation elements.

5. The business software application of claim 4, wherein the configuration of each navigation element is one of a location on the user interface of the navigation element, a visual representation of the navigation element, a sequence pattern of the navigation element and an action of the navigation element.

6. The business software application of claim 5, wherein the business software application is a customer relationship management application.

7. A method for navigating a business software application, the method comprising:
providing, on a computing device with a processing unit, a database and an application having a plurality of lines of computer code wherein the plurality of lines of computer code are executed by the processing unit of the computing device to generate a business application that accesses the database using one or more modules and one or more controllers, that has a user interface and that has a workflow with one or more screens in the workflow; and
generating one or more navigation elements, configured based on a prior use of the business application by a particular user, that allow the particular user to navigate to a particular screen within the workflow of the business application; and
displaying the one or more navigation elements on the user interface of the business application displayed on a display of the computing device.

8. The method of claim 7, wherein the one or more navigation elements are one of a top overlay, a floating window and a roll-over menu.

9. The method claim 7, wherein generating the one or more navigation elements further comprises adaptively determining the prior use of the business application by the particular user to automatically generates the one or more navigation elements.

10. The method claim 9 further comprising configuring, using an administrator portion of the application, the one or more navigation elements.

11. The method claim 10, wherein the configuration of each navigation element is one of a location on the user interface of the navigation element, a visual representation of the navigation element, a sequence pattern of the navigation element and an action of the navigation element.

12. A business software application, comprising:
a computing device with a processing unit;
a database;
an application having a plurality of lines of computer code wherein the plurality of lines of computer code are executed by the processing unit of the computing device to generate a business application client that accesses the database using one or more modules and one or more controllers; and
wherein the application has an expression engine that executes an expression for a process that is executed in a plurality of environments associated with the application.

13. The business software application of claim 12, wherein the expression engine is a web application scripting engine.

14. The business software application of claim 12, wherein each of the plurality of environments is one of a mid-tier environment, a client side environment, a storage tier environment and a distributed environment.

15. The business software application of claim 12, wherein each expression further comprises a trigger to determine if the expression has been satisfied and an action to be executed when the expression is satisfied.

16. The business software application of claim 15, wherein the trigger listens for a change in one or more field values to determine if the expression has been satisfied.

17. The business software application of claim 16, wherein the action is a function that modifies a value based on the expression.

18. The business software application of claim 17, wherein the action is a style action to change style of a field based on a string expression in the expression.

19. The business software application of claim 17, wherein the action is a value action that updates a value of a field by evaluating an parameter in the expression.

20. The business software application of claim 12, wherein the expression is a nested expression.

21. The business software application of claim 20, wherein the nested expression controls a workflow with more than one process, wherein each process is controlled by the nested expression.

22. The business software application of claim 12, wherein the business software application is a customer relationship management application.

23. A method for executing expressions in a business software application, the method comprising:
providing, on a computing device with a processing unit, a database and an application having a plurality of lines of computer code wherein the plurality of lines of computer code are executed by the processing unit of the computing device to generate a business application that accesses the database using one or more modules and one or more controllers; and
executing, using an expression engine of the application, an expression for a process that is executed in a plurality of environments associated with the application.

24. The method of claim 23, wherein each of the plurality of environments is one of a mid-tier environment, a client side environment, a storage tier environment and a distributed environment.

25. The method of claim 23, wherein each expression further comprises a trigger to determine if the expression has been satisfied and an action to be executed when the expression is satisfied.

26. The method of claim 25, wherein the trigger listens for a change in one or more field values to determine if the expression has been satisfied.

27. The method of claim 26, wherein the action is a function that modifies a value based on the expression.

28. The method of claim 25, wherein the action is a style action to change style of a field based on a string expression in the expression.

29. The method of claim 25, wherein the action is a value action that updates a value of a field by evaluating an parameter in the expression.

30. The method of claim 23, wherein the expression is a nested expression.

31. The method of claim 23, wherein the nested expression controls a workflow with more than one process, wherein each process is controlled by the nested expression.
